(19) United States
(12) Patent Application Publication
(10) Pub. No.: US 2007/0033350 A1
(43) Pub. Date: Feb. 8, 2007

(54) Ruined storage area marking and accessing method and system

(75) Inventors: Yi-Hung Shen, Hsin Chu (TW); Peng-Chao Wang, Hsin Chu (TW); Yu-Tsun Hsieh, Hsin Chu (TW)

Correspondence Address: EDWARDS & ANGELL, LLP, P.O. BOX 55874, BOSTON, MA, 02205, US

(73) Assignee: RDC Semiconductor Co., Ltd., Hsin Chu (TW)

(21) Appl. No.: 11/267,115

(22) Filed: Nov. 3, 2005

(30) Foreign Application Priority Data
Aug. 8, 2005 (TW) 094126687

(51) Int. Cl. G06F 13/00

(52) U.S. Cl. 711/154

(57) ABSTRACT

A ruined storage area marking and accessing method and system are proposed. The method and the system are for use with a data storage unit having a plurality of storage areas, for providing the data storage unit with a ruined storage area marking and accessing function to constantly inspect ruined storage areas and operable storage areas of the storage areas of the data storage unit. Therefore, when a client unit intends to access the data storage unit, addresses of the ruined storage areas would be redirected to addresses of the operable storage areas. When being applied to a system on chip (SOC), the method allows an embedded memory with ruined storage areas to be nevertheless operative without having to replace the entire chip.

### BACKGROUND OF THE INVENTION

1. Field of the Invention

The present invention relates to a computer system technology and, more particularly, to a ruined storage area marking and accessing method and system, both of which are designed for use in conjunction with a data storage unit having a plurality of storage areas for the purpose of providing the data storage unit with a ruined storage area marking and accessing function to inspect ruined storage areas and operable storage areas of the storage areas of the data storage unit. Therefore, when a client unit (for example, an internal microprocessor) wants to access the data storage unit, the ruined storage areas will be redirected to the operable storage areas automatically.

2. Description of Related Art

A system on chip (SoC) is a full functional chip module which integrates all functional components such as CPU, memory units, input/output interface units and other aided circuit units of a microcomputer system in a single chip. Therefore, a user can conveniently accomplish various control operations of the microcomputer only by the single chip. The functional components in a SoC are generally called embedded components, for example, a memory in a SoC is called an embedded memory.

In practical applications, storage areas of an embedded memory in a SoC may contain ruined storage areas which cannot be used to store data, thereby the access reliability problem may occur if there are ruined storage areas. However, the memory with ruined storage areas cannot be replaced at random as the embedded memory is fixed in the SoC. Alternatively, the entire chip including other unruined components such as CPU, input/output interface units and aided circuit units should be replaced if there are ruined storage areas in the embedded memory of the SoC, obviously it is not effective in economic cost.

To eliminate the aforementioned problem, as described in U.S. Patent Applications No. 20040225912 “MEMORY BUILT-IN SELF REPAIR (MBISR) CIRCUITS/DEVICES AND METHOD FOR REPAIRING A MEMORY COMPRISING A MEMORY BUILT-IN SELF REPAIR (MBISR) STRUCTURE”, and No. 20030196143 “POWER-ON STATE MACHINE IMPLEMENTATION WITH A COUNTER TO CONTROL THE SCAN FOR PRODUCTS WITH HARD-BISR MEMORIES”, a circuit technology is utilized to self repair ruined storage areas of a memory.

However, the embodiment for the above circuit technology needs more complicated circuits and more added circuit layout space, accordingly it is higher in cost.

Moreover, with the rapid development of DSM (Deep Sub-Micron) technology, embedded memory is becoming more and more important and popular in the semiconductor art as it occupies larger proportion in a SoC.

### SUMMARY OF THE INVENTION

To overcome the above-mentioned problems of the prior art, it is a primary objective of the present invention to provide a ruined storage area marking and accessing method and system, which can automatically inspect and markup ruined storage areas of an embedded memory, and redirect ruined storage areas to operable storage areas of the embedded memory. Therefore, the embedded memory, even with the ruined storage areas, can be nevertheless operability without having to replace an entire SoC chip where the embedded memory in installed.

It is another objective of the present invention to provide a ruined storage area marking and accessing method and system, which can be implemented in less complicated circuits and small circuit layout space, thereby the application of the method and system has more effective economic cost than the prior art.

The present invention provides a ruined storage area marking and accessing method and related system are designed for use in conjunction with a data storage unit for the purpose of providing the data storage unit having a plurality of storage areas with a ruined storage area marking and accessing function to inspect ruined and operable storage areas of the storage areas. Therefore, when a client unit (for example, an internal microprocessor) wants to access the data storage unit, the inspected ruined storage areas will be automatically redirected to the operable storage areas. The data storage unit is able to be a data storage device integrated in a System on Chip (SoC), such as an embedded memory, a cache, an external memory (for example, a flash memory) and the like.

The ruined storage area marking and accessing method of the present invention at least includes receiving an inspecting startup event; performing a storage detecting process on the data storage unit to detect ruined storage areas and operable storage areas of the storage areas of the data storage unit in response to the inspecting startup event; recording the ruined storage areas and the operable storage areas of the storage areas of the data storage unit, and redirecting the ruined storage areas to the operable storage areas of the storage areas, so as to set up an address mapping table to redirect the ruined storage areas onto the operable storage areas; inspecting whether access addresses of a request message issued by a client unit to the data storage unit include the addresses of the ruined storage area when the client unit issues the request message to the data storage unit, and redirecting the access addresses corresponding to the ruined storage areas to the addresses of the operable storage areas in accordance with the address mapping table if the access addresses are inspected to include the addresses of the ruined storage area; and accessing the mapped operable storage areas in place of the ruined storage areas.

The ruined storage area marking and accessing system according to the above method of the present invention at least includes a storage area inspecting module, which is used to respond an inspecting startup event and constantly inspecting ruined storage areas and operable storage areas of the storage areas of the data storage unit to check; a storage area recording module, which is used to record the ruined storage areas and the operable storage areas of the storage areas of the data storage unit, and redirect the ruined storage areas to the operable storage areas, so as to set up an address mapping table to redirect the ruined storage areas onto the operable storage areas; an access managing and controlling module, which is used to inspect whether access addresses of a request message issued by a client unit to the data storage unit include the addresses of the ruined storage area when the client unit issues the request message to the data storage unit, and redirect the access addresses corresponding to the ruined storage area to the addresses of the operable storage areas in accordance with the address mapping table if the access addresses are inspected to include the addresses of the ruined storage areas, and allow the client unit to access the mapped operable storage areas in place of the ruined storage areas.

The ruined storage area marking and accessing method and system of the present invention are characterized by the capability of constantly inspecting the operability of each storage area in the data storage unit to check whether any storage areas are ruined, so that when a client unit wants to gain access to ruined storage areas, the access can be automatically redirected to operable storage areas. When applied on SoC (System on Chip), this feature allows an embedded memory with ruined storage areas to be nevertheless operability without having to replace the entire chip.

### BRIEF DESCRIPTION OF DRAWINGS

The invention can be more fully understood by reading the following detailed description of the preferred embodiments, with reference made to the accompanying drawings, wherein:

FIG. 1 is a functional block diagram of a ruined storage area marking and accessing system of the preferred embodiment according to the present invention; and

FIG. 2 is a schematic diagram showing an address mapping table for mapping ruined storage areas onto operable storage areas of the ruined storage area marking and accessing system shown in FIG. 1.

### DETAILED DESCRIPTION OF PREFERRED EMBODIMENTS

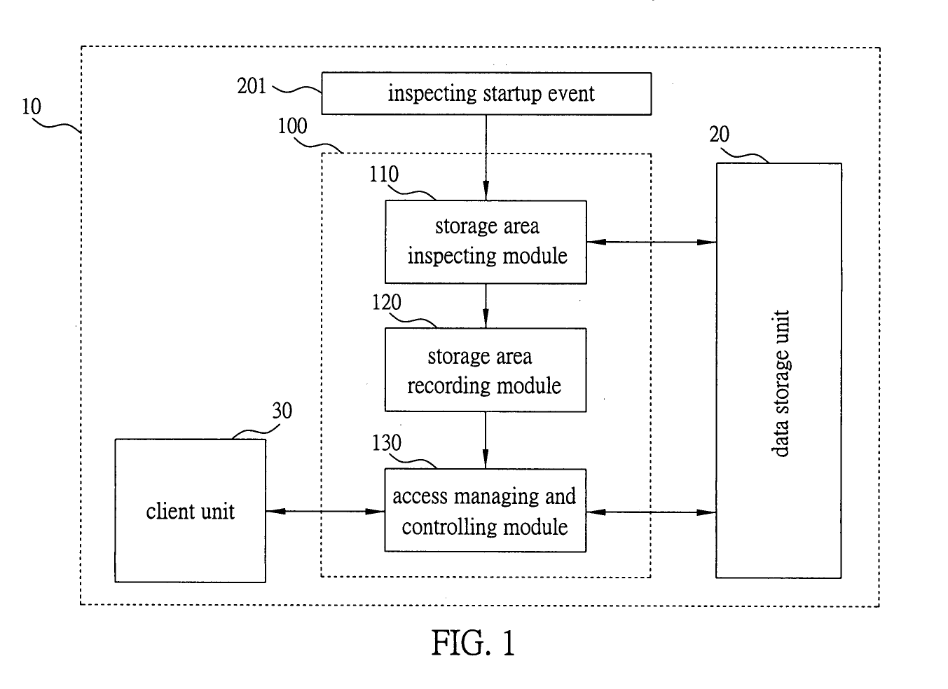

FIG. 1 is a functional block diagram of a ruined storage area marking and accessing system 100 of the preferred embodiment according to the present invention. As shown in FIG. 1, the ruined storage area marking and accessing system 100 is used in conjunction with a data storage unit 20 for the purpose of providing the data storage unit 20 having a plurality of storage areas with a ruined storage area marking and accessing function to detect ruined and operable storage areas of the storage areas of the data storage unit 20. Therefore, when a client unit (for example, an internal microprocessor 30) wants to access the data storage unit 20, the ruined storage areas will be redirected to the operable storage areas automatically. The data storage unit 20 is able to be a data storage device integrated in a system on chip (SoC) 10, such as an embedded memory, a cache, an external memory (for example, a flash memory) and the like.

As shown in FIG. 1, the ruined storage area marking and accessing system 100 at least comprises a storage area inspecting module 110, a storage area recording module 120, and an access managing and controlling module 130. In the present embodiment, the ruined storage area marking and accessing system 100 in conjunction with the data storage unit 20 is an internal circuit integrated in the SoC 10.

The storage area inspecting module 110 is used to respond an inspecting startup event 201, inspect operability of each of the storage areas of the data storage unit 20 (that is detect the ruined storage areas and the operable storage areas of the data storage unit 20) constantly to check whether the detected storage area of the data storage unit 20 is operable or ruined, and acquires addresses of the ruined storage areas. In the preferred embodiment, the inspecting startup event 201 is induced by a power-on event and a reset event of the SoC 10 reset, and a predefined startup signal of the SoC after a predefined time when the SoC 10 is idle.

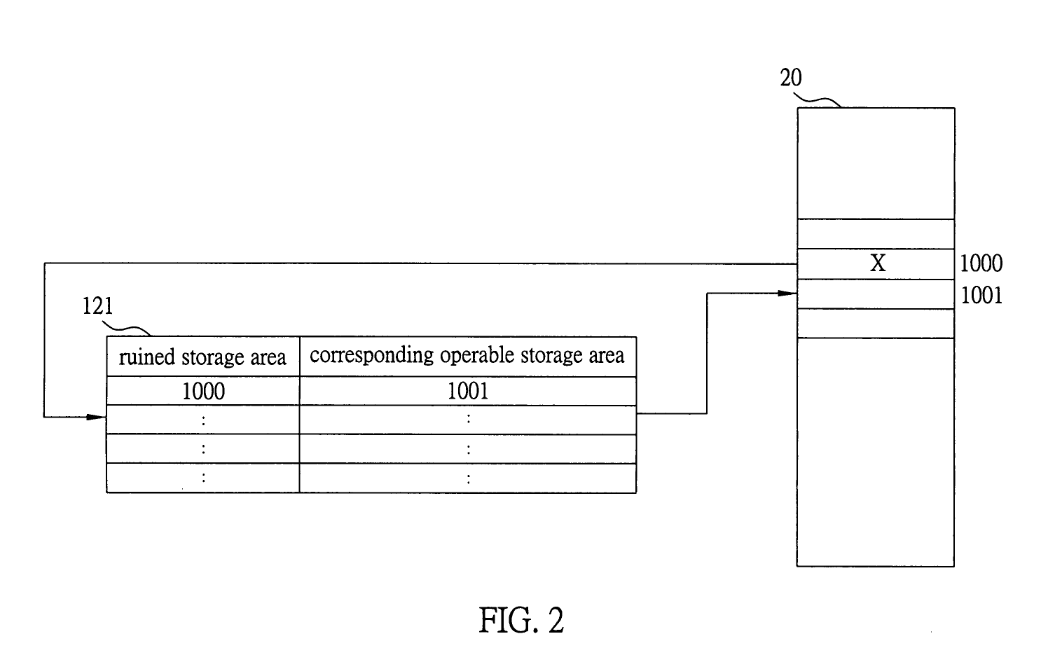

The storage area recording module 120 is used to record operability status of the storage areas (that is to record the detected ruined storage areas and the operable storage areas) of the data storage unit 20, and redirect the ruined storage areas to the operable storage areas, so as to set up an address mapping table 121, which is shown in FIG. 2, to redirect the ruined storage areas onto the operable storage areas. In the preferred embodiment, the address mapping table 121 of the storage area recording module 120 comprises a ruined storage areas table and an operable storage area table. The ruined storage area table records addresses of the operable storage areas, while the ruined storage area table records addresses of the ruined storage areas of the data storage unit 20. For instance, if a storage area [1000] of the data storage unit 20 is detected ruined and another storage areas after [1001] operable, the storage area recording module 120 records [1000] to the address mapping table 121 and redirects [1000] to an address of one of the operable storage areas, such as [1001].

The access managing and controlling module 130 is installed to receive an request message issued by an external or an internal client unit (for example, a microprocessor 30 in the SoC) to the data storage unit 20, and inspect whether access addresses of the request message include the addresses of the ruined storage areas. If the access addresses of the request message are all corresponding to the address of the operable storage areas, the access managing and controlling module 130 accesses the storage area unit 20 according to the received access addresses; on the other hand (i.e. the access addresses include at least one of the addresses of the ruined storage areas), the access managing and controlling module 130 redirects the ruined storage area to one of the operable storage areas in accordance with the address mapping table 121 recorded by the storage area recording module 120, and then accesses the operable storage areas of the data storage area unit 20 according to the redirected address and the access addresses except for the address of the ruined storage area. If the data storage unit 20 is a cache and the access addresses include an address of one of the ruined storage areas, the access managing and controlling module 130 responds a miss signal. For example, if the access addresses of the microprocessor 30 include the ruined storage area [1000], the access managing and controlling module 130 accesses the operable storage area [1001] in place of the ruined storage area [1000], because the ruined storage area [1000] has been redirected to the operable storage area [1001] by the storage area recording module 120 according to the address mapping table 121, as shown in FIG. 2. Accordingly, the ruined access induced by the ruined storage area [1000] can be prevented from occurrence.

Please refer to FIG. 1 and FIG. 2. The SoC 10 is designed to issue an inspecting startup event 201 automatically in response of a power-on event or a reset event of the SoC 10, a predefined startup signal of the SoC 10 after a predefined time when the SoC 10 is idle. Then the storage area inspecting module 110 of the ruined storage area marking and accessing system 100 inspects the data storage unit 20, i.e. to check whether any storage areas are ruined. If any ruined storage areas are detected, the storage area recording module 120 records addresses of the ruined storage areas and the operable storage areas that have been inspected by the storage area inspecting module 110 and redirects the ruined storage areas to the operable storage areas. For instance, if the storage area [1000] of the data storage unit 20 is detected ruined and the storage areas after [1001] are detected operable, the storage area recording module 120 records [1000] to the address mapping table and redirects [1000] to an address of one of the operable storage areas, such as [1001].

When an external or an internal client unit such as an internal microprocessor 30 wants to access the data storage unit 20, access addresses output by the microprocessor 30 are transmitted to the access managing and controlling module 130 first for checking whether the access addresses include any addresses of the ruined storage area. If the answer is no, the access managing and controlling module 130 allows the microprocessor 30 to access the data storage area unit 20; otherwise (for example, the access addresses include the ruined storage area [1000]), the access managing and controlling module 130 redirects the ruined storage area [1000] to the operable storage area [1001] according to the address mapping table 121 and then the microprocessor 30 is allowed to access the operable storage area [1001]. Accordingly, the ruined access induced by the ruined storage area [1000] can be prevented from occurrence. Therefore, the access to the ruined storage area [1000] can be automatically redirected to the access to the operable storage area [1001].

As a result, the present invention proposes a ruined storage area marking and accessing method and system, which is designed for use in conjunction with a data storage unit for the purpose of providing the data storage unit with a ruined storage area marking and accessing function which is characterized by the capability of constantly inspecting the operability of each storage area in the data storage unit to check whether any storage areas are ruined, so that when a client unit wants to gain access to ruined storage areas, the access can be automatically redirected to operable storage areas. When applied on SOC (System on Chip), this feature allows an embedded memory with ruined storage areas to be nevertheless operability without having to replace the entire chip. Therefore, the present invention has good progressiveness and practicability.

In summary, the foregoing descriptions are only the preferred embodiment and not restrictive of the technical scope of the present invention. The essential technical contents of the present invention are widely defined in the appended claims. All embodiments or methods accomplished by others which are the same as the definitions of the following claims or other equivalents should be considered as falling within the scope of the claims.

What is claimed is:

1. A ruined storage area marking and accessing method applicable in a data storage unit having a plurality of storage areas, for providing the data storage unit with a ruined storage area marking and accessing function, the ruined storage area marking and accessing method comprising the steps of:
receiving an inspecting startup event;
performing a storage detecting process on the data storage unit to detect ruined storage areas and operable storage areas of the storage areas of the data storage unit in response to the inspecting startup event;
recording the ruined storage areas and the operable storage areas of the storage areas of the data storage unit, and redirecting addresses of the ruined storage areas to addresses of the operable storage areas of the storage areas, so as to set up an address mapping table for redirection of the addresses of the ruined storage areas to the addresses of the operable storage areas;
inspecting whether access addresses of a request message issued by a client unit to the data storage unit include the addresses of the ruined storage areas when the client unit issues the request message to the data storage unit, and redirecting the access addresses corresponding to the ruined storage areas to the addresses of the operable storage areas in accordance with the address mapping table if the access addresses are inspected to include the addresses of the ruined storage areas; and
accessing the mapped operable storage areas in place of the ruined storage areas.

2. The ruined storage area marking and accessing method of claim 1, wherein the data storage unit is an embedded memory integrated in a system on chip (SoC).

3. The ruined storage area marking and accessing method of claim 1, wherein the data storage unit is a cache.

4. The ruined storage area marking and accessing method of claim 1, wherein the data storage unit is an external memory.

5. The ruined storage area marking and accessing method of claim 2, wherein the inspecting startup event is induced by a power-on event of the SoC.

6. The ruined storage area marking and accessing method of claim 2, wherein the inspecting startup event is induced by a reset event of the SoC.

7. The ruined storage area marking and accessing method of claim 2, wherein the inspecting startup event is induced by a predefined startup signal of the SoC issued after the SoC is idle for a predefined time.

8. A ruined storage area marking and accessing system for use with a data storage unit having a plurality of storage areas, for providing the data storage unit with a ruined storage area marking and accessing function, the ruined storage area marking and accessing system comprising:
a storage area inspecting module for performing a storage detecting process on the data storage unit to detect ruined storage areas and operable storage areas of the storage areas of the data storage unit in response to an inspecting startup event;
a storage area recording module for recording the ruined storage areas and the operable storage areas of the storage areas of the data storage unit, and redirecting addresses of the ruined storage areas to addresses of the operable storage areas, so as to set up an address mapping table for redirection of the addresses of the ruined storage areas to the addresses of the operable storage areas; and
an access managing and controlling module for receiving a request message issued by a client unit to the data storage unit and inspecting whether access addresses of the request message include the addresses of the ruined storage areas, and for redirecting the access addresses corresponding to the ruined storage areas to the addresses of the operable storage areas in accordance with the address mapping table if the access addresses are inspected to include the addresses of the ruined storage areas, so as to allow the mapped operable storage areas to be accessed in place of the ruined storage areas.

9. The ruined storage area marking and accessing system of claim 8, wherein the data storage unit is an embedded memory integrated in a SoC.

10. The ruined storage area marking and accessing system of claim 8, wherein the data storage unit is a cache.

11. The ruined storage area marking and accessing system of claim 8, wherein the data storage unit is an external memory.

12. The ruined storage area marking and accessing system of claim 9, wherein the inspecting startup event is induced by a power-on event of the SoC.

13. The ruined storage area marking and accessing system of claim 9, wherein the inspecting startup event is induced by a reset event of the SoC.

14. The ruined storage area marking and accessing system of claim 8, wherein the inspecting startup event is induced by a predefined startup signal of the SoC issued after the SoC is idle for a predefined time.
